(19) United States
(12) Patent Application Publication
(10) Pub. No.: US 2012/0126694 A1
(43) Pub. Date: May 24, 2012

(54) MERCURY-FREE HIGH INTENSITY GAS-DISCHARGE LAMP

(75) Inventors: Michael Haacke, Aachen (DE); Klaus Schoeller, Nideggen (DE)

(73) Assignee: KONINKLIJKE PHILIPS ELECTRONICS N.V., EINDHOVEN (NL)

(21) Appl. No.: 13/388,689

(22) PCT Filed: Aug. 6, 2010
(86) PCT No.: PCT/IB2010/053561

§ 371 Date: Feb. 3, 2012

(30) Foreign Application Priority Data
Aug. 13, 2009 (EP) 09167773.2
Aug. 28, 2009 (EP) 09168930.7

(51) Int. Cl. H01J 61/12; H01J 61/30; H01J 61/04; H01J 61/16

(52) U.S. Cl. 313/570; 313/637; 313/634; 313/631; 313/620

(57) ABSTRACT

The invention describes a mercury-free high intensity gas-discharge lamp (1) comprising a discharge vessel (5) enclosing a fill gas in a discharge chamber (2) and comprising a pair of electrodes (3, 4) extending into the discharge chamber (2), for which lamp (1) the fill gas in the discharge chamber (2) is free of zinc iodide, and the fill gas includes a halide composition comprising sodium iodide and scandium iodide to a combined proportion of at least 30 wt % and at most 95 wt %, and thulium iodide, to a proportion of at least 5 wt % and at most 70 wt %.

### FIELD OF THE INVENTION

The invention describes a mercury-free high intensity gas-discharge lamp.

### BACKGROUND OF THE INVENTION

In a high-intensity discharge lamp, an electric arc established between two electrodes produces an intensely bright light. Such a lamp is often simply referred to as a ‘HID’ lamp. In prior art HID lamps, a discharge chamber contains a fill gas comprising mostly xenon and a combination of halides—usually sodium iodide and scandium iodide—and one or more other metal salts that vaporise during operation of the lamp. Older HID lamps included mercury in the fill gas, since mercury has a high vapour pressure. For obvious health and environmental reasons, the use of mercury in such lamps is being phased out. When used in automotive headlamp applications, HID lamps have a number of advantages over other types of lamp. For instance, the light output of a metal halide xenon lamp is greater than that of a comparable tungsten-halogen lamp. Also, HID lamps have a significantly longer lifetime than filament lamps, and the halogen cycle ensures that these lamps are not subject to blackening. These and other advantages make HID lamps particularly suited for automotive headlamp applications.

Along with the colour temperature, other characteristics of such lamps, for example operational voltage, lamp driver characteristics, dimensions, etc., are specified in different countries by the appropriate regulations, for example by ECE-R99 in Europe, where ‘ECE’ stands for ‘Economic Commission for Europe’. Often, the lamps specified in these regulations are simply referred to by their designation, e.g. ‘D1’, ‘D4’, etc.

The light output and the colour of the light of an automotive lamp are crucial for safety. Firstly, the headlamps of a vehicle must sufficiently illuminate the road for the driver of that vehicle, and secondly, other drivers should not be subject to potentially dangerous glare from the headlamps of that vehicle. Prior art xenon HID lamps used in headlights normally provide a light with a colour temperature up to 4000K.

The colour of an automotive headlight must comply with certain standards in order to ensure uniformity and therefore also to promote safety for drivers. One such standard is the SAE system, which was developed by the Society of Automotive Engineers in the USA to define the colours for automotive headlights, and which will be known to a person skilled in the art. Studies have shown that the colour temperature of an automotive lamp should be considerably higher than 4000 K, and the X and Y coordinates of the corresponding colour point, as graphed using the SAE system, should lie on or close to the black-body line (a locus of points corresponding to an ideal black body radiator). As will be known to the skilled person, colour points with different X and Y coordinates can have the same colour temperature. Therefore, the colour characteristics of different lamps are preferably compared from the point of view of the proximity of the colour point to the black-body line. For example, a lamp with a colour temperature of 5000 K can have a colour point with coordinates ‘above’ the black-body line, so that its light is perceived to be yellowish. Another lamp, also with a colour temperature of 5000 K, can have a colour point with coordinates ‘below’ the black-body line, so that its light is perceived to be blueish. Light with a colour point below the black-body line—for example blueish-white light—is perceived by the human eye to be brighter than light with a colour point above the black-body line having a yellow hue. An automotive headlight with a colour point close to or below the black-body line can improve recognition in the dark, therefore increasing safety in night-time driving. These requirements are leading to an increased demand on the part of customers for xenon HID lamps with high efficiency mentioned, but also with a higher colour temperature.

However, designing lamps to produce a light with the desired higher colour temperature and with a colour point close to the black-body line—away from the ‘yellow’ region of an SAE chart and towards the ‘blue’ region—is not necessarily a straightforward process, since, under equal conditions, the luminous flux output by a lamp producing blue light is lower than that of a lamp producing yellow light. For this reason, it is difficult to obtain a lamp that delivers light with a colour temperature greater than 4500 K with an acceptable level of luminous flux. Attempts to raise the colour temperature in prior-art lamps usually involve adding indium iodide (InI) and zinc iodide (ZnI₂) to a sodium iodide (NaI) and scandium iodide (ScI₃) mixture. In state of the art lamps, for example in D1 or D2 lamps (containing mercury), a loss of light output up to 30% is observed, so that the efficiency of these lamps is unsatisfactory. Other D3 and D4 lamps (mercury-free) achieve a light output only marginally satisfying the regulation requirements, for example a light output of only 3200±450 lm.

In brief, none of the previous approaches have been able to effectively raise the colour temperature without suffering from a loss in light output. For example, EP 1 768 165 A2 describes a mercury-free high-pressure discharge lamp with a fill gas comprising, for example, sodium iodide and thulium iodide. As another necessary constituent of the fill gas, zinc iodide is used. However, a satisfactory lumen output is only delivered by these fill gas compositions when included in high-power lamps such as 100 W, which need to be driven at correspondingly high voltages. This document also mentions one other example as a comparison, in which the fill gas only comprises sodium iodide and thulium iodide. In this example, the lamp voltage obtained is too low (27V) and the luminous efficiency is unsatisfactory (only 45 lm/W) for use in an automotive application. For this reason, in most state of the art lamps, zinc iodide was included in the fill gas in order to be able to achieve a higher operation voltage. However, the use of zinc iodide results in a loss in light output of up to 10%. Furthermore, the necessity of zinc iodide as an additional constituent in prior art lamps raises the cost of each lamp accordingly.

Therefore, it is an object of the invention to provide a more economic mercury-free high-intensity xenon discharge lamp that satisfies the criteria for a D1-D4 automotive headlamp, while having a high colour temperature as well as a high luminous flux.

### SUMMARY OF THE INVENTION

To this end, the present invention describes a mercury-free high intensity gas-discharge lamp comprising a discharge vessel enclosing a fill gas in a discharge chamber and comprising a pair of electrodes extending into the discharge chamber, for which lamp the fill gas in the discharge chamber is free of zinc iodide, and the fill gas includes a halide composition comprising sodium iodide (NaI) and scandium iodide (ScI₃) to a combined proportion of at least 30 wt % and at most 95 wt %, and thulium iodide (TmI3), to a proportion of at least 5 wt % and at most 70 wt %.

Experiments with the lamp according to the invention, which does not include zinc in the fill gas composition, have—surprisingly—shown that the absence of zinc does not have a noticeable effect on the lamp voltage. At the same time, a significantly higher light output can be achieved with at least 30 wt % combined sodium iodide and scandium iodide in the fill gas. Therefore, by omitting zinc iodide and compiling the fill gas to include this minimum combined amount of sodium iodide and scandium iodide, the lamp according to the invention allows a higher light output to be achieved, without the lamp voltage being adversely affected in any way. In a simple and economic solution, therefore, the lamp according to the invention provides a particularly high light output while being more cost-effective to manufacture than prior art lamps.

Another obvious advantage of the lamp according to the invention is that, with the fill gas described, a very high level of light output (lumen) per Watt, i.e. a high level of efficiency, can be reached with a colour temperature well placed in the blue-white region required for automotive applications. The addition of thulium iodide (TmI₃) results in a significant increase in the colour temperature that can be reached at this high level of lamp efficiency. In particular, even for a lamp with a lower nominal power, e.g. 25 W, a favourable colour temperature close to the black-body line can be achieved having the same colour impression as a D4 lamp.

Advantageously, the lamp according to the invention can be used in place of a prior art D1-D4 headlamp without having to replace any existing electronics or fittings, so that the customer requirements mentioned in the introduction can be met.

The dependent claims and the subsequent description disclose particularly advantageous embodiments and features of the invention.

Even a small amount of at least 5 wt % of thulium iodide in the salt fill of the lamp can ensure a satisfactory colour point for the lamp. However, to obtain a lamp with a more blueish colour, preferably at least 15 wt %, more preferably at least 20 wt % thulium iodide is included in the lamp filling.

In the following, pertinent initial lamp parameters such as colour temperature, operating voltage, lumen output etc., apply for a lamp age of 15 hours according to ECE regulations. This is because these parameters are obtained after the first fifteen hours of operation of such a lamp, which is regarded as the ‘ageing’ time.

As mentioned above, it is highly desirable in automotive applications for the colour temperature of a headlight to lie close to the black-body line in an SAE representation, as will be known to a person skilled in the art. Therefore, in a particularly preferred embodiment of the invention, the halide composition of the lamp also comprises indium iodide (InI) to a proportion of at least 0.1 wt % and at most 40 wt %. The addition of indium iodide serves to lower the Y-coordinate of the colour point. By appropriate choice of the proportions of the metal salts in the fill gas, a colour temperature can be obtained whose colour point has X and Y-coordinates that lie on, or at least very close to, the black-body line.

The combined amount of sodium iodide and scandium iodide in the fill gas, as already indicated, serves to yield a high efficiency of the lamp. Evidently, the relative proportions of these metal salts can be adjusted as required. With approximately equal levels of sodium iodide and scandium iodide, i.e. 50:50, the lumen output of the lamp is only subject to minor alteration, while allowing the x-coordinate of the colour point to be positioned closer to the black-body line. On the other hand, increasing the relative proportion of sodium iodide while decreasing that of scandium iodide serves to prolong the lifetime maintenance of the lamp, i.e. the lamp can provide relatively constant lumen output over a longer lifetime. Therefore, in a further preferred embodiment of the invention, the proportion of sodium iodide in the halide composition is at least 15 wt % and at most 60 wt %, and the proportion of scandium iodide in the halide composition is at least 10 wt % and at most 40 wt %.

Further adjustments of the colour temperature can be obtained with the addition of small amounts of other rare earth compounds in the fill gas. By adding a small amount of one or more additional rare earth metal salts, the x- and/or y-coordinate of the colour point can be adjusted so that a desired colour temperature can be obtained precisely. Therefore, in a further embodiment of the invention, the halide composition preferably comprises one or more additives of a group of rare earth halides comprising dysprosium iodide (DyI₃), thallium iodide (TlI), neodymium iodide (NdI₃), and holmium iodide (HoI3), to a proportion of at most 10%. The lumen output and the colour point of an HID lamp are governed by many factors, such as fill gas composition, dimensions of the discharge chamber, size and position of the electrodes, etc. Furthermore, the physical construction of the lamp, the conditions under which it is operated, and the pressure of the fill gas in the lamp all serve to influence its light output. Therefore, in a further preferred embodiment of the invention, the construction parameters of the lamp and the composition of the fill gas are chosen such that the lamp can be driven to attain a colour temperature in the range of 4000 K to 7000 K in the SAE field. The fill gas in the lamp preferably comprises xenon gas under a pressure of at least 12 bar and at most 17 bar in a non-operational state. This is referred to as the ‘cold pressure’ of the lamp.

For automotive headlight applications to date, lamps rated at 35 W are generally used. Therefore, the lamp according to the invention preferably has a rated or nominal power of 35 W. The physical construction characteristics of the lamp are preferably such that the capacity of the discharge chamber of the lamp is at least 15 μl and at most 30 μl, while the inner diameter of the discharge chamber can be between 2.2 mm and 2.6 mm, preferably 2.4 mm, and the outer diameter of the discharge chamber can be between 5.9 mm and 6.3 mm, preferably 6.1 mm. In such a lamp, the halide composition in the fill gas of the lamp preferably has a combined weight of at least 100 μg and at most 400 μg.

However, the lamp according to the invention is, advantageously, not limited to a 35 W realisation. With appropriate choice of construction parameters, the lamp can also be realised, for example, as a 25 W lamp. In such a lamp, the capacity of the discharge chamber is at least 10 μl and at most 25 μl, having an inner diameter measuring between 2.0 mm and 2.4 mm, preferably 2.2 mm, and an outer diameter measuring between 4.5 mm and 6.1 mm, preferably 5.5 mm. In this lower-power realisation, the halide composition in the fill gas preferably has a combined weight of at least 50 μg and at most 300 μg.

The electrodes of HID lamps are generally made of tungsten, since tungsten has a very high melting point, as will be known to the skilled person. A tungsten electrode that contains thorium (called a thoriated tungsten electrode) operates at a temperature below its melting temperature compared to a pure tungsten electrode, so that the electrode is not so prone to deformation during operation. In the lamp according to the invention, the electrodes can be thoriated or even essentially thorium-free, as desired.

To obtain a stable arc using such an electrode, experiments pertaining to the lamp according to the invention have shown that the dimensions of the electrode can play an important role. Maintenance of a stable arc depends to a large extent on the geometry of the electrodes, in particular their diameter, since the thickness of the electrodes governs the electrode temperature that is reached during operation, which in turn determines the commutation behaviour and the burn-back of the electrodes according to the ballast parameters. The diameter of the electrode within a pinch region of the lamp is therefore preferably at least 200 μm, and the diameter at the tip of the electrode is preferably at most 400 μm. The electrode can be realised as a simple rod shape of uniform diameter from tip to pinch, or can be realised to be wider at the tip that at the pinch. Evidently, these dimensions apply to the initial dimensions of the electrodes before burning.

As is known to a person skilled in the art, the electrodes in a HID lamp of the type described here protrude from opposite sides into the discharge chamber, so that the tips of the electrodes are separated by a small gap. In the lamp according to the invention, the electrode tips are preferably separated by a real distance of at least 3 mm and at most 5 mm, preferably 3.6 mm. The optical separation between the electrode tips, i.e. the separation as seen through the glass of the inner chamber, will appear larger than the actual separation. An electrode separation of 3.6 mm corresponds to an optical separation of 4.2 mm.

A lamp of the type described above preferably comprises an outer chamber within which the discharge chamber is disposed. This outer chamber can be transparent quartz glass, or it can be treated to influence the colour of the emitted light. Therefore, in a further preferred embodiment of the invention, the discharge chamber of the lamp is disposed within a quartz glass outer chamber, which outer chamber is treated with a compound of neodymium, for example neodymium oxide (Nd₂O₃) and/or a compound of cobalt, for example cobalt aluminate CoAl₂O₄. The effect of these compounds is to absorb yellow light emitted by the lamp during operation. For example, neodymium oxide has a strong absorption band centred at a wavelength of 580 nm so that this yellow light does not pass through the outer chamber wall. The treatment of the outer chamber can therefore comprise, as appropriate, an actual doping of the quartz glass from which the outer chamber is made, or a coating applied to a surface of the outer chamber.

Other objects and features of the present invention will become apparent from the following detailed descriptions considered in conjunction with the accompanying drawings. It is to be understood, however, that the drawings are designed solely for the purposes of illustration and not as a definition of the limits of the invention.

### BRIEF DESCRIPTION OF THE DRAWINGS

FIG. 1 shows a cross section of a gas-discharge lamp according to an embodiment of the invention;

FIG. 2 shows a cross section of a gas-discharge lamp according to a further embodiment of the invention;

FIG. 3 shows a table of experimental results using a number of embodiments of the lamp according to the invention.

FIG. 4 shows an SAE chart of the colour point of a D4S lamp after 15 h burning;

In the drawings, like numbers refer to like objects throughout. Objects in the diagrams are not necessarily drawn to scale.

### DETAILED DESCRIPTION OF THE EMBODIMENTS

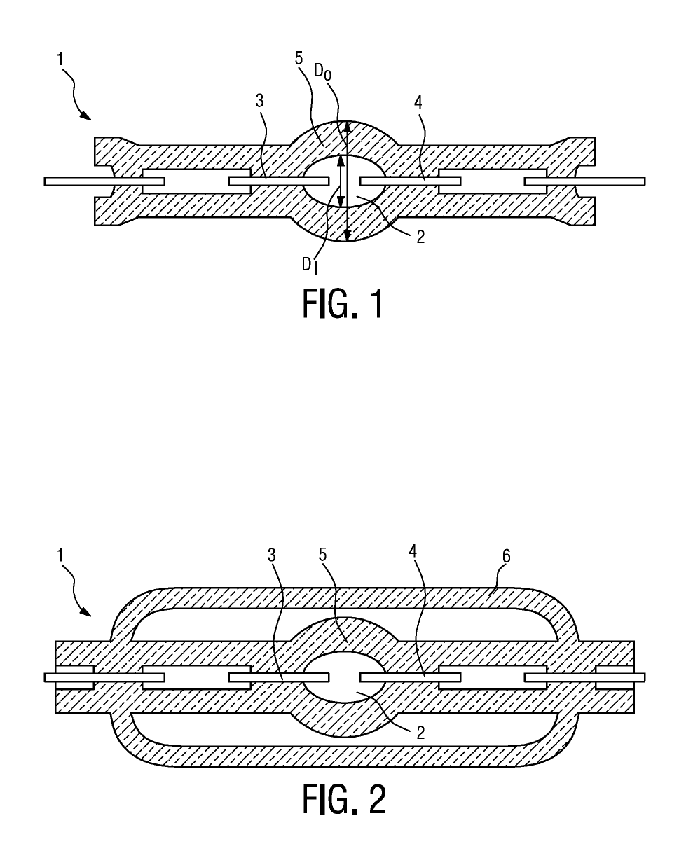

In FIG. 1, a cross section of a quartz glass gas-discharge lamp 1 is shown according to an embodiment of the invention. Essentially, the lamp 1 comprises a quartz glass discharge vessel 5 enclosing a discharge chamber 2 containing a fill gas. Two electrodes 3, 4 protrude into the discharge chamber 2 from opposite ends of the lamp 1. During manufacturing, the quartz glass of the discharge vessel 5 is pinched on both sides around the electrodes 3, 4 to seal the fill gas in the discharge chamber 2. The capacity (or volume) of the discharge chamber 2 is governed by the inner diameter Dᵢ and outer diameter Dₒ of the discharge vessel 5. The inner and outer diameters Dᵢ, Dₒ are measured at the widest point.

The electrodes 3, 4 in this embodiment are tungsten rods that protrude into the discharge chamber 2 and are optically separated from each other by a distance of 4.2 mm according to the R99 regulation. The electrodes of a lamp according to the invention can be realised as simple rods of uniform thickness from base to tip. In the embodiment described in the diagram, electrodes 3, 4 are shown with a diameter of 300 μm (this value of diameter is the initial value before burning). However, the thickness of the electrodes can equally well vary over different stages of the electrodes, so that, for example, an electrode is thicker at its tip and narrower at the base.

For the sake of clarity, the diagram shows only the parts that are pertinent to the invention. Not shown is the base and the ballast that is required by the lamp for control of the voltage across the electrodes. When the lamp 1 is switched on, the ballast's igniter rapidly pulses an ignition voltage at several thousand volts across the electrodes 3, 4 to initiate a discharge arc. The heat of the arc vaporises the metal salts in the fill gas. Once the arc of high luminous intensity is established, the ballast regulates the power, so that the voltage across the electrodes 3, 4 accordingly drops to the operational level, in this example, to a level between 38V and 55V.

Since potentially damaging ultraviolet light is generated by the arc in the HID lamp 1, the quartz discharge vessel 5 may be enclosed by a doped quartz glass shield or envelope to absorb this radiation. Such an outer chamber 6 is shown in FIG. 2. This outer chamber 6 can be treated by doping the glass itself, for example with neodymium oxide (Nd₂O₃), or by applying a coating of, for example, cobalt aluminate CoAl₂O₄ to an inner or outer surface of the outer chamber 6, using techniques that are known to the skilled person. This treatment ensures that yellow light is absorbed, allowing a further improvement of the colour of the light emitted by the lamp 1. The light that is passed through is then collected and distributed using HID-specific optics, not shown in the diagram, such as reflectors and collimators in headlamp construction for ensuring that as much as possible of the light output is put to use. Since these and other additional components will be known to a person skilled in the art, they will not be explained in more detail.

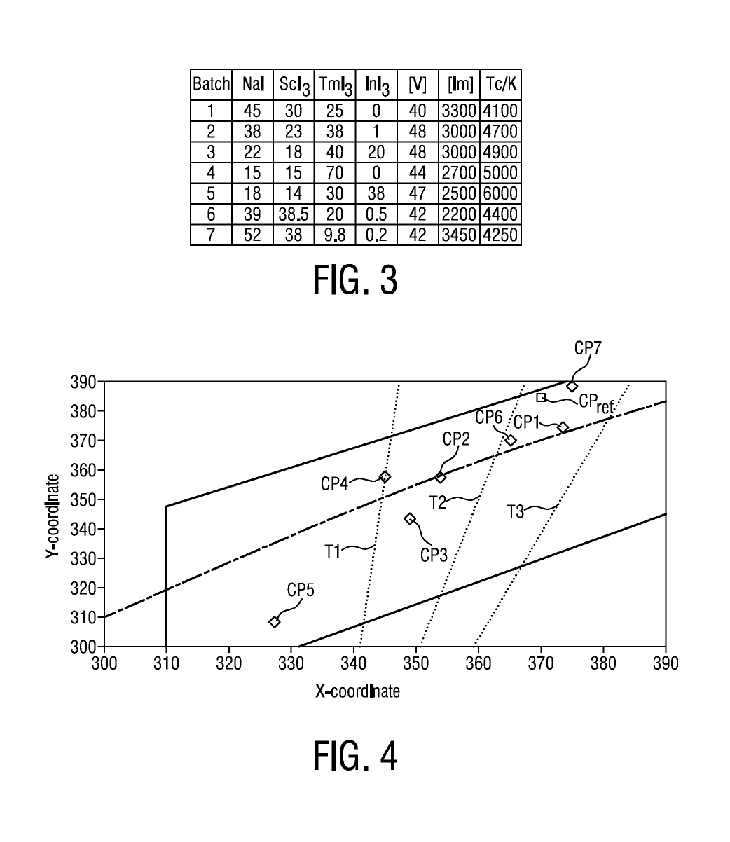

In tests with lamps containing zinc iodide, a satisfactory luminous flux was not obtained for a light with a desired colour temperature in the region of 5000K. For example, a lamp with a fill gas comprising sodium iodide (8 wt %), scandium iodide (7 wt %), thulium iodide (72 wt %) and zinc iodide (13 wt %), a luminous flux of only 2400 lm was obtained, with a lamp voltage of 44V. In another test, a lamp with a fill gas comprising sodium iodide (10 wt %), scandium iodide (10 wt %) and thulium iodide (80 wt %) was tested. Even though zinc iodide was omitted from the fill gas composition, a lamp voltage of 44V was reached, with an increase in luminous flux at 2600 lm. This shows that the inclusion of zinc iodide is not necessary for maintaining a desired lamp voltage, and omitting the zinc iodide even has a positive effect on the light output. However, the perceived brightness of these lamps can still be improved in view of the automotive requirements outlined in the introduction. Better results were obtained using a fill gas composition according to the invention, as will be demonstrated with the aid of FIG. 3, which shows a table of results obtained in a series of experiments with D4S lamps according to the invention, with measurements taken after 15 hours of burning. The first column lists the batch number of the experimental results for the corresponding row (batches 1 to 5 and batch 7 comprised lamps designed for with a nominal power of 35 W, while batch 6 comprised 25 W lamps). The next four columns list the percentages of a number of metal halides in the fill gas composition.

As can be seen from the table, the first batch, with a fill gas composition with 45 wt % NaI, 30 wt % ScI₃ and 25 wt % TmI₃, achieves an operating voltage 40V, a light output of 3,300 lm, and a colour temperature of 4100 K, with a very favourable proximity to the black-body line. A higher colour temperature of 4700 K and a higher operating voltage are obtained by lamps of the second batch, which has a fill gas composition with 38 wt % NaI, 23 wt % ScI₃, 38 wt % TmI₃ and 1% InI. Here, the addition of indium iodide gives a very advantageous placement on the black-body line for that colour temperature. The fifth batch, with a fill gas composition with 18 wt % NaI, 14 wt % ScI₃, 30 wt % TmI₃ and 38% InI gives a very high colour temperature of 6000 K. Even though the lumen output of these lamps is somewhat lower at 2500 lm, this is still exceptionally high for lamps with such a colour temperature. Even more favourable from the point of view of colour perception is the position of the colour point for these lamps, namely below the black-body line, so that the light output has no yellowish components. Lamps of the sixth batch, comprising 25W lamps with 20 wt % TmI₃ and 0.5 wt % InI (and also 2 wt % ThI₄) delivered less lumen output, but surprisingly exhibited a better colour point for their colour temperature of 4400 K, namely closer to the black-body line, so that their light output is perceived to be essentially white, and not yellow. The seventh batch obtained an extremely favourable light output—3450 lumen—and a colour point within the reglement. The colour points of the lamps in batches 1, 2, 4 and 6 were experimentally observed to lie favourably close to or even on the black-body line, making these lamps particularly suitable for automotive headlamps.

In FIG. 4, a graphical realisation of the experimental results of FIG. 3 is shown in an SAE graph, which plots the X and Y co-ordinates of the observed colour points. The solid black lines indicate the ‘reglement’, or the limits for a permissible range in colour temperature while the broken line represents the black-body line. Three relevant colour temperature curves are given by the dotted lines T1, T2, T3 which correspond to colour temperatures of 5000K, 4444K, and 4000K respectively. The region enclosed by the lines T1, T3 covers a blue/white/green region in the SAE colour graph. Colour temperatures ‘lower’ than 4000 K, i.e. to the right of the line T3, tend to have a yellowish/red hue. The colour point CP_{ref} corresponds to a reference lamp with the usual addition of zinc iodide in the fill gas. As can be seen from the diagram, the colour point achieved by this lamp is close to the reglement boundary. The colour points CP1-CP7 correspond respectively to the batches 1-7 listed in the table of FIG. 3. The colour point CP1 corresponds to lamp from the first batch, with 25% TmI₃ in the fill gas. This lamp yields a satisfactory colour temperature with a colour point on the black-body line. Colour points CP2, CP4, CP6 are also on or near the black-body line, and therefore deliver satisfactory values for colour temperature and luminous flux. Colour point CP7 is within an acceptable distance above the black-body line, while colour points CP3, CP5 are very favourably positioned below the black-body line, and the colour points of these lamps remain within the permissible range bounded by the reglement.

Although the present invention has been disclosed in the form of preferred embodiments and variations thereon, it will be understood that numerous additional modifications and variations could be made thereto without departing from the scope of the invention. The lamp according to the invention is not limited to the above type of embodiment for use in automotive applications, but is also suited for use in a ceramic discharge metal halide (CDM) lamp, with applications such as outdoor lighting. For the sake of clarity, it is also to be understood that the use of “a” or “an” throughout this application does not exclude a plurality, and “comprising” does not exclude other steps or elements.

1. A mercury-free high intensity gas-discharge lamp (1) comprising a discharge vessel (5) enclosing a fill gas in a discharge chamber (2) and comprising a pair of electrodes (3, 4) extending into the discharge chamber (2), for which lamp (1)
the fill gas in the discharge chamber (2) is free of zinc iodide, and
the fill gas includes a halide composition comprising sodium iodide and scandium iodide to a combined proportion of at least 30 wt % and at most 95 wt %, and thulium iodide to a proportion of at least 5 wt % and at most 70 wt %.

2. A lamp (1) according to claim 1, wherein the halide composition comprises thulium iodide to a proportion of at least 20 wt %.

3. A lamp (1) according to claim 1, wherein the halide composition comprises indium iodide to a proportion of at least 0.1 wt % and at most 40 wt %.

4. A lamp (1) according to claim 1, wherein the construction parameters of the lamp (1) and the composition of the fill gas are chosen such that a colour temperature in the range of 4000 K to 7000 K is attained by the lamp (1) during operation.

5. A lamp (1) according to claim 1, wherein the fill gas comprises xenon gas under a pressure of at least 12 bar and at most 17 bar in a non-operational state.

6. A lamp (1) according to claim 1, wherein the proportion of sodium iodide in the fill gas is at least 15 wt % and at most 60 wt %, and the proportion of scandium iodide in the fill gas is at least 10 wt % and at most 40 wt %.

7. A lamp (1) according to claim 1 with a nominal power of 35 W, and for which lamp (1)
the capacity of the discharge chamber (2) is greater than or equal to 150 and less than or equal to 30 μl;
the inner diameter of the discharge chamber (2) comprises at least 2.2 mm and at most 2.6 mm;
the outer diameter of the discharge chamber (2) comprises at least 5.9 mm and at most 6.3 mm; and
the halide composition in the fill gas of the lamp (1) has a combined weight of at least 100 μg and at most 400 μg.

8. A lamp (1) according to claim 1 with a nominal power of 25 W, and for which lamp (1)
the capacity of the discharge chamber (2) is greater than or equal to 10 μl and less than or equal to 25 μl;
the inner diameter of the discharge chamber (2) comprises at least 2.0 mm and at most 2.4 mm;
the outer diameter of the discharge chamber (2) comprises at least 4.5 mm and at most 6.1 mm; and
the halide composition in the fill gas of the lamp (1) has a combined weight of at least 50 μg and at most 300 μg.

9. A lamp (1) according to claim 1, wherein the halide composition comprises one or more additives of a group of rare earth halides comprising dysprosium iodide, thallium iodide and holmium iodide, to a proportion of at most 10%.

10. A lamp (1) according to claim 1, wherein the electrodes (3,4) are arranged at opposing ends of the discharge chamber (2) and wherein an electrode (3, 4) of the lamp (1) is a tungsten electrode (3, 4), for which electrode (3, 4)
the diameter of the electrode (3, 4) within a pinch region of the lamp (1) is at least 200 μm;
and the diameter at the tip of the electrode (3, 4) is at most 400 μm.

11. A lamp (1) according to claim 1, wherein the tips of the electrodes (3, 4) are separated by a distance of at least 3 mm and at most 5 mm.

12. A lamp (1) according to claim 1, wherein the discharge vessel (5) of the lamp (1) is disposed within a quartz glass outer chamber (6), which outer chamber (6) is treated with a compound of neodymium and/or a compound of cobalt.
